(19) United States
(12) Patent Application Publication
(10) Pub. No.: US 2015/0096189 A1
(43) Pub. Date: Apr. 9, 2015

(54) METHOD OF DRYING CANNABIS MATERIALS

(71) Applicants: Matthew D Hawes, Orrington, ME (US); Matthew R Cohen, Ukiah, CA (US)

(72) Inventors: Matthew D Hawes, Orrington, ME (US); Matthew R Cohen, Ukiah, CA (US)

(21) Appl. No.: 14/050,286

(22) Filed: Oct. 9, 2013

(51) Int. Cl. F26B 21/08

(52) U.S. Cl. CPC F26B 21/08
USPC 34/474

(57) ABSTRACT

A method for drying cannabis plant material is provided. The method includes loading cannabis plant material into a chamber, setting the humidity of the chamber to a first humidity level for a first time period and setting the temperature of the chamber to a first temperature for the first time period, and setting the humidity of the chamber to a second humidity level, and optionally the temperature of the chamber to a second temperature, until the water content of the cannabis plant material reaches a first desired percentage. The method may further include setting the humidity of the chamber to a third humidity level and/or the temperature of the chamber to a third humidity level until the water content of the cannabis plant material reaches a second desired percentage.

### BACKGROUND OF THE INVENTION

1. Field of the Invention

The present invention relates generally to a method of drying cannabis materials, and more specifically to a method of drying cannabis plant materials using controlled atmospheric conditions to enhance the dried product and reduce unwanted elements such as spores while also protecting cannabinoids, terpenes and flavanoids.

2. Description of the Related Art

The cannabis plant can be employed medicinally, therapeutically, and recreationally. The cannabis plant, or cannabis, contains a number of chemical compounds called cannabinoids that activate cannabinoid receptors on cells that repress neurotransmitter release in the brain. The most well known cannabinoid is the phytocannabinoid Δ⁹-tetrahydrocannabinol (THC), which is the primary psychoactive compound of the cannabis plant. At least 85 different cannabinoids may be extracted from the cannabis plant, including cannabidiol (CBD), cannabinol (CBN), tetrahydrocannabivarin (THCV), and cannabigerol (CGB).

Cannabis has been used for many hundreds of years to treat a variety of medical conditions. Historically, cannabis was known to have a unique ability to counteract pain resistant to opioid analgesics. The use of cannabis as prescription medicine is being revisited as a way to treat pain, seizure, and many other conditions.

Cannabis plant material is generally dried after harvest, because it cannot otherwise be effectively consumed by traditional methods. Living cannabis leaves contain about 80 percent water, but drying the cannabis material produces a plant material that may be stored for a period of time while retaining potency, taste profiles, and medicinal values and efficacy. However, excess drying and/or drying methods that employ too much or too high a heat will generally evaporate some of the volatile oils that give cannabis its unique taste and aroma.

A number of methods to dry cannabis plant material exist. The most common of these methods is probably slow drying. Whole plants or separated colas are dried, generally in a cool dark room or other enclosed space. The cannabis material may be hung from a string or from pegs on a wall or laid out on drying screens. Screen drying involves spreading out cannabis buds on screens to dry. The screens can be laid out or placed in a dehydrator. Drawbacks to screen drying include extra labor in removing leaves from buds and removing buds from the stems, which can be a large amount of labor for big harvests. Because the stem is removed, the buds dry very quickly, making the cannabis harsher tasting. Screen drying also results in uneven drying, because small buds dry more quickly than larger buds.

With a drying line, colas, branches, or entire plants may be hung upside down from wire or rope lines running from wall to wall. This makes a convenient temporary hanging system, but as the bud dries, the water in the stem slowly wicks into the bud, which slows down the drying process. The slower drying process does result in a smoother taste than drying screens. Another method of slow drying is cage drying. Buds can be hung from wire cages. Because the cages can be picked up and moved, they can easily be moved closer or further from heaters, fans and dehumidifiers as needed to ensure even drying.

Methods of speeding up the drying process include the use of fans, which decrease the chance of mold and speed along the drying process, heaters, which drive down the humidity levels and speed up the drying process (and also reduce mold), and dehumidifiers. Fast drying produces a harsher end product than slow drying, but is often the most convenient method. In addition, it is believed in the industry that fast drying can not only damage cannabinoids, terpenes and flavonoids, but can also prevent the plant from reaching peak potency during the cure phase because of locked in chlorophyll.

In industrial applications, current producers of cannabis plant materials are generally using dehumidification alone to dry cannabis materials. Standard, or in some cases industrial, dehumidifiers are placed in an area with the freshly harvested materials. There is typically no drying schedule being followed. Instead, the dehumidifiers are run at full strength until the cannabis materials are adequately dry. Moreover, mold spores are a problem in current methods of drying cannabis plant material and are not adequately controlled in those methods.

It would be advantageous to provide a method of drying cannabis plants that overcomes or addresses the issues associated with previous cannabis drying methods.

### SUMMARY OF THE INVENTION

According to one aspect of the present design, there is provided a method for drying cannabis plant material comprising loading the cannabis material into a chamber, setting the humidity of the chamber to a first humidity level for a first time period, setting the humidity of the chamber to a second humidity level until the water content of the cannabis material reaches a first desired percentage. The method may further comprise setting the temperature of the chamber to a first temperature for the first time period. In embodiments, the first temperature is between about 100 and about 150 degrees Fahrenheit. In further embodiments, the first temperature is between about 120 and about 145 degrees Fahrenheit, or between about 115 and about 145 degrees Fahrenheit.

The method for drying cannabis plant material may further comprise decreasing the temperature of the chamber to a second temperature after the first time period. The second temperature may be between about 55 and about 110 degrees Fahrenheit. In further embodiments, the second temperature may be between about 65 and about 85 degrees Fahrenheit. In other embodiments, the second temperature may be between about 60 and about 100 degrees Fahrenheit.

In further embodiments, the first humidity level is between about 40 and about 100 percent humidity. In further embodiments, the first humidity level is between about 50 and about 80 percent humidity. In other embodiments, the first humidity level is between about 60 and about 100 percent humidity. The second humidity level is between about 20 and about 60 percent humidity. In further embodiments, the second humidity level may be between about 30 and 50 percent humidity. In embodiments, the first time period is about 5 hours or less. In further embodiments, the first time period is between about 1 minute and about 5 hours. In still further embodiments, the first time period is between about 10 minutes and about 5 hours. In alternate embodiments, the first time period is between about 15 minutes and about 70 minutes. In embodiments, the first desired percentage of the water content of the cannabis material is between about 20 and about 60 percent.

The method for drying cannabis plant material may further comprise setting the humidity of the chamber to a third humidity level until the water content of the cannabis material reaches a second desired percentage. In further embodiments, the method further comprises adjusting the temperature of the chamber to a third temperature after the water content of the cannabis material reaches the first desired percentage. The third temperature may be between about 50 and about 85 degrees Fahrenheit. In further embodiments the third humidity level is between about 15 and about 65 percent humidity.

In embodiments, the method provided herein reduces spores contained in the cannabis material are by at least 99.9% when the water weight reaches the second desired percentage.

### BRIEF DESCRIPTION OF THE DRAWINGS

For a more complete understanding of the present disclosure, reference is now made to the following figures, wherein like reference numbers refer to similar items throughout the figures:

FIG. 1 illustrates a drying chamber according to one embodiment.

FIG. 2 illustrates a flow chart of a drying process according to one embodiment.

### DETAILED DESCRIPTION

The following description and the drawings illustrates specific embodiments sufficiently to enable those skilled in the art to practice the method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The present design relates to a method for drying cannabis plant material using controlled atmospheric conditions, although the method of the present disclosure may be used to generally dry any plant material known to contain cannabinoids. Cannabis plants include wild cannabis plants, including but not limited to the species Cannabis sativa, Cannabis indica, and Cannabis ruderalis, as well as their variants.

Plant material as described herein may include any plant or plant part. Generally, cannabis plants are dried either as whole plants, in branches or colas, or as just the buds of the cannabis plants. Healthy plants usually form one main cola from the center of the plant's branching structure, with smaller colas forming around the outside of the plant.

Cannabis can be contaminated by spores, generally mold spores, before or during a drying process. Example spores that may contaminate cannabis include black mold (Aspergillus spp.), brown rot (Monilinia fructigen, Monilinia laxa), gray mold (Botrytic cinerea), penicillium mold (Penicillium spp.), rhizopus rot (Rhizopus stolonifer), colletotrichum rot (Colletotrichum gloeosporioides), snow mold (Fusarium spp.), and mucor mold (Mucor spp.). This list of example spores is by no means exhaustive and is not meant to exclude any of the other spores or contaminants that could contaminate cannabis. If there are enough spores, effects to a user can include upper respiratory breathing problems, coughing, diarrhea, vomiting and even more severe symptoms that could potentially result in death. It is thus desired to reduce spore count in dried cannabis plant material. Some state regulations even limit the maximum spore count that can be present in cannabis offered for sale. The method of the present design kills a significant majority of potentially hazardous spores without compromising the cannabis.

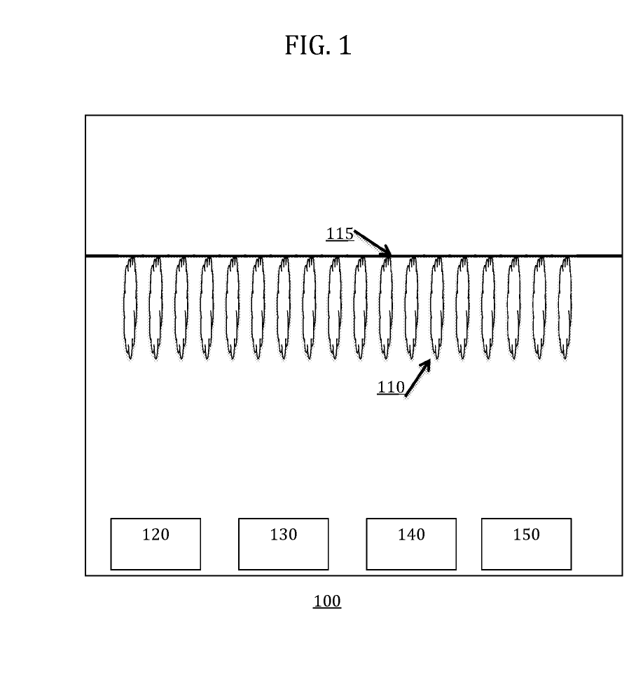

According to the present design, harvested cannabis plant material that is ready for drying may be loaded into a chamber. One embodiment of a chamber 100 is shown in FIG. 1. The chamber 100 as shown contains a drying line 115 or other method of holding the cannabis material 110. This can include drying racks, screens, tables, shelves, wall hooks and/or even the floor. The chamber 100 may be small enough to dry a small amount of cannabis or as large as a factory building or any size in between. The chamber 100 may be a container, room, building or any other type of enclosure or apparatus that can fit a desired amount of cannabis plant material. The chamber 100 is equipped so that temperature and humidity may be monitored and adjusted. The chamber may include heating and cooling elements. For example, a heating element/source 120 may be an electric heating coil, heat lamp or other heating device. Other heating sources such as propane, natural gas, geo-thermal, or any reasonably available source could be used. Multiple heating elements/sources of different types may be used in combination. A cooling element 130 may be a condensing coil, evaporator coil or other cooling element.

The chamber 100 may also include elements that increase humidity and decrease humidity. FIG. 1 shows a humidity increasing element 140 and a humidity decreasing element 150. A dehumidifier may be used to reduce humidity, for example, and a device such as a spray mist device may be used to add humidity, for example. In one embodiment, the chamber may include a dehumidifier, a spray mist device that can add humidity, a condensing coil that can cool like an air conditioner, and an electric heating coil. In this embodiment, the chamber can be heated and/or cooled and its humidity can be raised and/or lowered.

Although one configuration of a chamber 100 is shown in FIG. 1 with block elements, other configurations of chambers are also included in the present disclosure with varying combinations of elements.

The chamber may also be capable of measuring the water weight of the cannabis starting material during the drying process. For example, a load cell or moisture content probe may monitor a sample piece's weight. If the starting moisture content of the sample piece is known, the moisture content may be calculated in real time by monitoring the overall loss in weight throughout the process, all of which may be assumed to be attributed to lost water weight. Other methods may be used to monitor water weight of the cannabis plant. These methods may be made automatically or through use of equipment inside or connected to the chamber. It is also possible to make manual calculations, for example by retrieving samples and calculating lost water weight outside of the chamber.

The conditions in the chamber may be changed manually or automatically on a schedule. The schedule may be based upon known times for weights or volumes of starting material to reach desired water content levels. In embodiments, the schedule of changes to the atmospheric conditions is based on a combination of known times and real time analysis of water content levels.

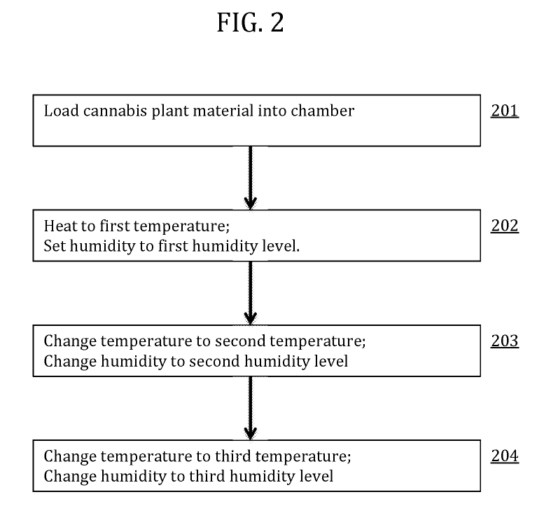

In embodiments, and as illustrated in the flow chart of FIG. 2, the chamber is loaded with the plant material in step 201. The chamber with the loaded cannabis plant material is altered to desired atmospheric conditions. It is possible to change the atmospheric conditions prior to or after loading the cannabis material. Specifically, in a first stage, the humidity level of the chamber and the temperature of the chamber are set to desired levels. In the first stage, and in each of the stages that follows, it is preferable that the atmospheric conditions remain constant throughout the stage. However, it is possible that atmospheric conditions could be adjusted according to a curve or other schedule during each of the stages/phases.

In the first stage 202, the humidity level and temperature are set to levels sufficient to thermally kill the majority of spores in the cannabis plant material. The chamber is heated to a first temperature and the humidity is set to a first humidity level. In addition to the thermal spore kill function of the first stage, moisture is added to the chamber to raise and/or maintain humidity levels. The humidity is raised to prevent the core of the product from experiencing evaporative cooling. If the humidity levels drop to too low a level, evaporation from the core causes the internal temperature of the product to drop. When this happens, the external temperature must be raised to compensate for the evaporative cooling. This is problematic because ingredients present in the product such as cannabinoids, flavonoids and terpenes are adversely affected by heat. Cannabinoids, as discussed herein, are a class of diverse chemical compounds that activate cannabinoid receptors on cells that repress neurotransmitter release in the brain. Flavonoids are a class of plant secondary metabolites and are desirable for human consumption, because they have benefits such as anti-allergenic, anti-inflammatory, anti-microbial, anti-cancer, and anti-diarrheal effects. Terpenes are a class of organic compounds and are the primary constituents of the essential oils of many plants and flowers. The terpenes give cannabis some of its strain specific effects as well as unique smell and taste. To reduce the adverse effect on these and other compounds, the temperature is preferably kept as low as possible but high enough to effectively kill spores. Raising humidity in this particular environment can result in the temperature being kept as low as possible.

Adding moisture and raising humidity also prevents the product from drying too fast during the initial spore kill period. When the product dries too quickly, the chlorophyll within the leaves becomes locked in and is not able to evaporate off along with water from within the leaf materials. When the chlorophyll is locked into the leaf materials, the product is left with a harsh smell and taste, which has a negative effect on the quality and value of the product. For these reasons, it is preferred that moisture be added to the environment to raise humidity during the first stage of the dry cycle.

In embodiments, the first humidity level and first temperature in the first stage of the dry cycle are set for a first time period. The first time period may be a predetermined time period designed to kill the maximum number of spores with the least degradation of the cannabis plant material. The first time period is preferably less than about five hours. For example, the time period may be between about one minute and about five hours. In further embodiments, the first time period is between about ten minutes and about five hours. In further embodiments, the time period is between about fifteen and about seventy minutes. The first temperature is preferably above a level that is sufficient to kill the majority of spores present in cannabis plant material. For example, a temperature of about 100 degrees Fahrenheit of above is sufficient to kill the majority of spores present. In further embodiments, the temperature is also sufficiently low to avoid degradation of the cannabis plant material. For example the first temperature may be between about 100 degrees and about 150 degrees Fahrenheit. More particularly, the first temperature may be between about 120 degrees and about 145 degrees Fahrenheit.

The first humidity level is sufficient to offset the temperature increase, avoiding large amounts of evaporation from the core and avoiding negative effects on the quality and value of the product. For example, the humidity level may be set above about 40 percent humidity, for example between about 40 and about 100 percent humidity. In further embodiments, the humidity level may be set to between about 40 and about 80 percent humidity or between about 60 and about 100 percent humidity. In further embodiments, the humidity level may be set between about 50 and about 80 percent humidity or between about 40 and about 70 percent humidity.

In further embodiments, the spore count of the cannabis plant material or a sample of the cannabis plant material may be measured to determine whether sufficient thermal spore kill has been affected. Thus, instead of using a predetermined amount of time that has been tested and determined to kill off sufficient spores, the time for the first stage may be variable and chosen in real time based on the actual measured kill rate.

After the first stage, a second stage may be used to dry the cannabis plant material after sufficient thermal spore kill. This second stage is a water content reduction phase. As shown in FIG. 2, in the second step/stage 203 the chamber is changed to a second temperature and the humidity is changed to a second humidity level. Because of the adverse effects of heat discussed herein, it is preferred in this stage for the cannabis plant material to lose water content through an atmosphere with a significant dry bulb/wet bulb depression. This essentially means a low relative humidity, which allows the material to lose water content as a result of dry conditions, not due to heat. In embodiments, the temperature is rapidly lowered by use of a cooling so as to stop any high temperature effects as soon as possible. The temperature of the chamber may be set to a second temperature element, for example to a temperature below about 110 degrees Fahrenheit. The temperature is preferably adjusted to between about 55 and about 110 degrees Fahrenheit. In further embodiments, the temperature may be adjusted to between about 65 and about 85 degrees Fahrenheit. Alternately, the temperature may be adjusted to between about 60 and about 100 degrees Fahrenheit.

The humidity of the chamber is set to a second humidity level. The second humidity level may be below about 60 percent humidity, for example between about 20 and about 60 percent humidity. In more particular embodiments, the humidity level may be between about 30 and about 50 percent humidity or between about 30 and about 50 percent humidity. These atmospheric conditions are preferably maintained until the water content of the cannabis plant material reaches a desired percentage. For example, the desired percentage may be between about 20 and about 60 percent water content left in the plant material. The second stage preferably gets the moisture content of the cannabis plant material down to a level at which any remaining mold spores are unlikely to reproduce. Moreover, it is preferred to lower the moisture content of the chamber, and of the plants therein, quickly so that any spore(s) that might have survived the thermal spore kill of the first stage are not likely to reproduce or spread.

The second stage may be continued until the cannabis plant material is dried further or drying may be completed outside the chamber, either through traditional drying methods or in a separate chamber. In other embodiments, the chamber is adjusted to a third humidity level and may also be adjusted to a third temperature. The third stage, step 204 in FIG. 2, provides an ideal environment for the cannabis plant material to achieve equilibrium moisture content. The temperature may be changed to a third temperature and the humidity may be changed to a third humidity level. The atmospheric conditions are preferably similar to the environment in a humidor such that the dried cannabis plant material could remain in the environment indefinitely and maintain ideal moisture content. This stage allows for materials of all sizes and densities to gradually arrive at the ideal moisture content through equilibrium. Use of this stage is preferable, because it allows cannabis plant material of various sizes and densities to ultimately arrive at uniform moisture contents. This stage may be continued until water weight of the cannabis plant material reaches a second desired percentage.

In certain embodiments, the third humidity level is maintained between about 15 and about 65 percent humidity. The humidity level range may be lower, for example between about 15 and about 55 percent humidity. In further embodiments, the humidity level may be above about 20 percent humidity. In still further embodiments the humidity level range may be between about 20 percent humidity and about 65 percent humidity or between about 20 percent humidity and about 55 percent humidity. The third temperature may be between about 50 and about 80 degrees Fahrenheit or a smaller range of between about 55 and about 70 degrees Fahrenheit. The final water weight (or, second desired percentage) may vary slightly depending on the desired product and subjective opinions. One range that has shown good results is between about five and about eleven percent water content of the cannabis plant material.

In the embodiments described herein, the thermal spore kill of the drying method allows for a reduction of the initial spore count by at least 99.9%.

While primarily described herein with respect to an exemplary process for drying cannabis plant material, the invention and disclosure herein are not intended to be so limited. Note that while certain examples are provided herein, these examples are meant to be illustrative and not limiting as to the functionality of the present system and method. Other examples and implementations are possible and this document should not be limited by the examples presented.

Various values of temperature and humidity are provided herein. Temperature and humidity values greater or less than those provided may be employed in certain circumstances, and inclusion of values is not intended to be limiting. Thus if in certain conditions temperatures of X, Y, Z, and A have been disclosed, it is to be understood that those may be maximum or minimum values for the parameter. The present disclosure is intended to be interpreted broadly in this regard

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for drying cannabis plant material, comprising:
loading the cannabis plant material into a chamber;
setting the humidity of the chamber to a first humidity level for a first time period and setting the temperature of the chamber to a first temperature for the first time period;
setting the humidity of the chamber to a second humidity level until the water content of the cannabis plant material reaches a first desired percentage.

2. The method of claim 1, wherein the first temperature is between about 100 and about 150 degrees Fahrenheit.

3. The method of claim 1, wherein the first temperature is between about 120 and about 145 degrees Fahrenheit.

4. The method of claim 1, further comprising decreasing the temperature of the chamber to a second temperature after the first time period.

5. The method of claim 4, wherein the second temperature is between about 55 and about 110 degrees Fahrenheit.

6. The method of claim 1, wherein the first humidity level is between about 40 and about 100 percent humidity.

7. The method of claim 1, wherein the second humidity level is between about 20 and about 60 percent humidity.

8. The method of claim 1, wherein the first time period is between about 10 minutes and about 5 hours.

9. The method of claim 1, wherein the first time period is between about 15 minutes and about 70 minutes.

10. The method of claim 1, wherein the first desired percentage is between about 20 and about 60 percent.

11. The method of claim 1, further comprising:
setting the humidity of the chamber to a third humidity level until the water content of the cannabis plant material reaches a second desired percentage.

12. The method of claim 11, further comprising adjusting the temperature of the chamber to a third temperature after the water content of the cannabis plant material reaches the first desired percentage.

13. The method of claim 12, wherein the third temperature is between about 50 and about 85 degrees Fahrenheit.

14. The method of claim 11, wherein the third humidity level is between about 15 and about 65 percent humidity.

15. The method of claim 1, whereby spores contained in the cannabis plant material are reduced by at least 99.9% when the water weight reaches the second desired percentage.

16. A method for drying cannabis plant material, comprising:
loading the cannabis plant material into a chamber;
setting the humidity of the chamber to a first humidity level for a first time period and setting the temperature of the chamber to a first temperature for the first time period;
setting the humidity of the chamber to a second humidity level and the temperature of the chamber to a second temperature until the water content of the cannabis plant material reaches a first desired percentage; and
setting the humidity of the chamber to a third humidity level and the temperature of the chamber to a third temperature until the water content of the cannabis plant material reaches a second desired percentage.

17. The method of claim 16, wherein the first desired percentage is between about 20 and about 60 percent and the second desired percentage is between about 5 and about 11 percent.

18. The method of claim 16, wherein the first temperature is between about 100 degrees and about 150 degrees Fahrenheit and the first humidity level is between about 40 and about 100 percent humidity.

19. The method of claim 16, wherein the second temperature is between about 55 and about 110 degrees Fahrenheit and the second humidity level is between about 20 and about 60 percent humidity.

20. A method for drying cannabis plant material, comprising:
loading the cannabis plant material into a chamber;
setting the humidity of the chamber to a first humidity level of between about 40 and about 100 percent for a first time period and setting the temperature of the chamber to a first temperature of between about 100 and about 150 degrees Fahrenheit for the first time period, wherein the first time period is between about 15 and about 70 minutes;
setting the humidity of the chamber to a second humidity level of between about 20 and about 60 percent and the temperature of the chamber to a second temperature of between about 55 and about 110 degrees Fahrenheit until the water content of the cannabis plant material reaches a first desired percentage of between about 20 and about 60 percent;
setting the humidity of the chamber to a third humidity level of between about 15 and about 65 percent and the temperature of the chamber to a third temperature of between about 50 and about 80 degrees Fahrenheit until the water content of the cannabis plant material reaches a second desired percentage of between about 5 and about 11 percent.
